(19) United States
(12) Patent Application Publication
(10) Pub. No.: US 2023/0367627 A1
(43) Pub. Date: Nov. 16, 2023

(54) Seamless Multi Asset Application Migration Between Platforms

(71) Applicant: Google LLC, Mountain View, CA (US)

(72) Inventors: Chen Dar, Kiryat-Ono (IL); Gil Fidel, Petah Tikva (IL); Erez Geva, Petah Tikva (IL); Leonid Vasetsky, Zikhron Yaakov (IL); Eyal Yaron, Givatayim (IL)

(21) Appl. No.: 17/740,540

(22) Filed: May 10, 2022

(51) Int. Cl. G06F 9/48; H04L 9/40

(52) U.S. Cl. CPC G06F 9/4856; H04L 63/20

(57) ABSTRACT

Generally disclosed herein is an approach for identifying multi-asset applications for migrating from a first platform to a second platform. The approach includes creating a graph representing assets executing in the first platform. Nodes of the graph can represent assets and edges of the graph can represent logical relationships between the assets. Logical relationships can be determined based on network connection information of data relevant to identifying the multi-asset applications. A grouping of at least two nodes connected by an edge can represent a multi-asset application. The approach can further include creating network and security policies for the identified multi-asset applications and deploying the policies to the second platform for migrating the multi-asset applications from the first platform to the second platform.

### BACKGROUND

Migrating applications between platforms can be a complex task. Simply moving a virtual machine for an application usually is not sufficient because there can be dependencies left out of the migration. For example, an application server can be migrated without the database, even though the server is dependent on the database. As another example, a single micro-service can be migrated without assets on which it depends. Further, migrating applications between platforms can require additional preparations to understand context for the migration.

### BRIEF SUMMARY

Generally disclosed herein is an approach for migrating one or more multi-asset applications from a first platform to a second platform. The approach can include identifying multi-asset applications in the first platform. Based on relevant data, a graph having nodes and edges can be created to represent the first platform. Nodes can be assets, such as virtual machines, processes, storage systems, and databases. Edges can be relations between the assets, such as network connections, storage connections, and interprocess connections. The edges can connect two nodes to illustrate a logical relationship between two assets. A grouping of at least two nodes connected by an edge can represent a multi-asset application. The approach can further include creating network and security policies for the identified multi-asset applications and deploying the policies to the second platform. The assets can be migrated to the second platform and configured to run on the second platform based on the network and security policies.

An aspect of the disclosure provides for a method for migrating multi-asset applications from a first platform to a second platform. The method includes receiving, with one or more processors, data for identifying one or more multi-asset applications of the first platform. The method further includes creating, with the one or more processors, a graph representation of the first platform based on the received data, where the graph representation includes a plurality of nodes representing assets of the first platform. The method also includes calculating, with the one or more processors, connections between the nodes based on logical relationships between the assets, where the graph representation further includes a plurality of edges between nodes representing the connections. The method further includes identifying, with the one or more processors, the multi-asset applications based on the connections between the nodes. The method also includes migrating, with the one or more processors, the identified multi-asset applications from the first platform to the second platform.

In an example, the method further includes creating, with the one or more processors, policies for the identified multi-asset applications; and deploying, with the one or more processors, the policies on the second platform; where migrating the identified multi-asset applications from the first platform to the second platform is based on the policies. In another example, the identified multi-asset applications run on the second platform during migration. In yet another example, the policies include network and security policies.

In yet another example, the method further includes mapping, with the one or more processors, the calculated connections to resources of the second platform. In yet another example, mapping the calculated connections includes one of configuring the second platform to reflect infrastructure in the first platform or configuring the multi-asset applications to reflect the target platform.

In yet another example, the received data includes one or more of asset information uniquely identifying one or more assets, network connection information identifying one or more connections between assets, or process information identifying functions of one or more assets.

In yet another example, two nodes connected by an edge represent a multi-asset application.

Another aspect of the disclosure provides for a system including one or more processors; and one or more storage devices coupled to the one or more processors and storing instructions that, when performed by the one or more processors, causes the one or more processors to perform operations for migrating multi-asset applications from a first platform to a second platform. The operations include receiving data for identifying one or more multi-asset applications of the first platform. The operations further include creating a graph representation of the first platform based on the received data, where the graph representation includes a plurality of nodes representing assets of the first platform. The operations also include calculating connections between the nodes based on logical relationships between the assets, where the graph representation further includes a plurality of edges between nodes representing the connections. The operations further include identifying the multi-asset applications based on the connections between the nodes. The operations also include migrating the identified multi-asset applications from the first platform to the second platform based on the calculated connections.

In an example, the operations further include creating policies for the identified multi-asset applications; and deploying the policies on the second platform; where migrating the identified multi-asset applications from the first platform to the second platform is based on the policies. In another example, the identified multi-asset applications run on the second platform during migration. In yet another example, the policies include network and security policies.

In yet another example, the operations further include mapping the calculated connections to resources of the second platform. In yet another example, mapping the calculated connections includes one of configuring the second platform to reflect infrastructure in the first platform or configuring the multi-asset applications to reflect the target platform.

In yet another example, the received data includes one or more of asset information uniquely identifying one or more assets, network connection information identifying one or more connections between assets, or process information identifying functions of one or more assets.

In yet another example, two nodes connected by an edge represent a multi-asset application.

Yet another aspect of the disclosure provides for a non-transitory computer readable medium for storing instructions that, when executed by one or more processors, causes the one or more processors to perform operations for migrating multi-asset applications from a first platform to a second platform. The operations include receiving data for identifying one or more multi-asset applications of the first platform. The operations further include creating a graph representation of the first platform based on the received data, where the graph representation includes a plurality of nodes representing assets of the first platform. The operations also include calculating connections between the nodes based on logical relationships between the assets, where the graph representation further includes a plurality of edges between nodes representing the connections. The operations further include identifying the multi-asset applications based on the connections between the nodes. The operations also include migrating the identified multi-asset applications from the first platform to the second platform based on the calculated connections.

In an example, the operations further include creating policies for the identified multi-asset applications; and deploying the policies on the second platform; wherein migrating the identified multi-asset applications from the first platform to the second platform is based on the policies.

In another example, the operations further include mapping the calculated connections to resources of the second platform. In yet another example, mapping the calculated connections comprises one of configuring the second platform to reflect infrastructure in the first platform or configuring the multi-asset applications to reflect the target platform.

### BRIEF DESCRIPTION OF THE DRAWINGS

FIG. 1 depicts a block diagram of an example environment for implementing an approach to migrate multi-asset applications according to aspects of the disclosure.

FIG. 2 depicts a block diagram of an example platform according to aspects of the disclosure.

FIG. 3 depicts a block diagram of another example platform according to aspects of the disclosure.

FIG. 4 depicts a flow diagram of an example process for migrating multi-asset applications from a source platform to a target platform according to aspects of the disclosure.

FIG. 5 depicts an example graph representation of a platform according to aspects of the disclosure.

FIG. 6 depicts the example graph representation after calculating connections according to aspects of the disclosure.

FIG. 7 depicts a block diagram of an example migration from a source platform to a target platform based on the example graph representation according to aspects of the disclosure.

FIG. 8 depicts a block diagram of the example migration where all multi-asset applications have been migrated to the target platform according to aspects of the disclosure.

FIG. 9 depicts a block diagram of an example computing system for performing a multi-asset application migration according to aspects of the disclosure.

### DETAILED DESCRIPTION

Generally disclosed herein is an approach for migrating one or more multi-asset applications from a first platform to a second platform. The approach for migrating multi-assets can include identifying multi-asset applications in the first platform. Relevant data for identification can be received from the first platform. Relevant data can include asset information, network connection information, and process information.

Based on the received relevant data, a graph can be created to represent the first platform. The graph can include nodes and edges. Nodes can be assets, such as virtual machines, processes, storage systems, and databases. Edges can be relations between the assets, such as network connections, storage connections, and interprocess connections. The edges can connect two nodes to illustrate a logical relationship between two assets. The edges can include a direction from one node to another node to illustrate a dependency between two assets. The connections of the graph can be calculated using a graph traversal algorithm, as an example. A grouping of at least two nodes connected by an edge can represent a multi-asset application.

The approach can further include creating network and security policies for the identified multi-asset applications. The connections of the graph are analyzed and mapped to resources of the second platform. The created network and security policies can be deployed to the second platform. The assets can be migrated to the second platform and configured to run on the second platform during migration or as soon as the migration is complete based on the network and security policies.

The approach allows for maintaining functionality of multi-asset applications during migration to a target platform. For example, connectivity between dependent assets can be maintained during the migration process, since the dependencies have been identified. The system can remain operational during migration, even if migration occurs in parts. The approach can be used for containerizing assets as well for modernization. Modernization can allow for migrating to a managed service for databases, message queues, monitoring, and logging, as examples.

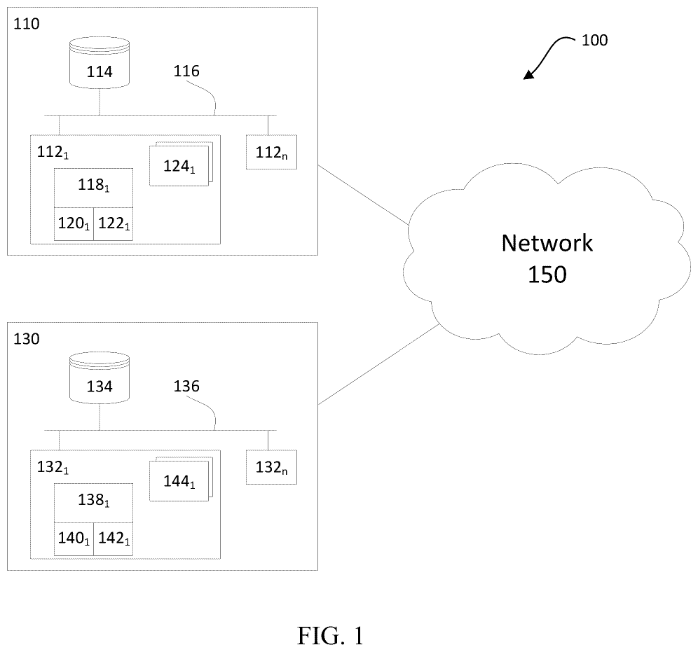

FIG. 1 depicts a block diagram of an example environment 100 for implementing the approach to migrate multi-asset applications from a first platform 110 to a second platform 130 over a network 150. The platforms 110, 130 can include services that allow for provisioning or maintaining compute resources and/or applications, such as data centers, cloud environments, and/or container frameworks. For example, the platforms 110, 130 can be used as a service that provides software applications, e.g., accounting, word processing, inventory tracking, etc. applications. As another example, the infrastructure of the platforms 110, 130 can be partitioned in the form of virtual machines or containers on which software applications are run. While only two platforms are shown, it should be understood that the environment 100 can include any number of platforms.

The first platform 110 can be illustrated as including one or more host machines 112 and storage 114 connected via infrastructure 116. The host machines 112 can support or execute a virtual computing environment. While two host machines 112 are shown, it should be understood that the first platform 110 can include any number of host machines 112. Each host machine 112 can include memory 118 for storing instructions 120 and data 122, and one or more processors 124 for executing the instructions 120 using the data 122.

The memory 118 can store information accessible by the one or more processors 124, including the instructions 120 and data 122 that can be executed or otherwise used by the processors 124. The memory 118 can be of any type capable of storing information accessible by the processors 124, including a computing device-readable medium, or other medium that stores data that may be read with the aid of an electronic device, such as a hard-drive, memory card, ROM, RAM, DVD, or other optical disks, as well as other write-capable and read-only memories. Systems and methods may include different combinations of the foregoing, whereby different portions of the instructions and data are stored on different types of media.

The instructions 120 can be any set of instructions to be executed directly, such as machine code, or indirectly, such as scripts, by the processors 124. For example, the instructions 120 can be stored as computing device code on a computing device-readable medium. In that regard, the terms “instructions” and “programs” may be used interchangeably herein. The instructions 120 can be stored in object code format for direct processing by the processor 124, or in any other computing device language including scripts or collections of independent source code modules that are interpreted on demand or compiled in advance. Processes, functions, methods, and routines of the instructions 120 with respect to multi-asset application migration are explained in more detail below.

The data 122 can be retrieved, stored, or modified by the processors 124 in accordance with the instructions 120. As an example, the data 122 associated with the memory 118 can include data used in supporting services for one or more client devices, applications, etc. Such data may include data to support hosting web-based applications, file share services, communication services, gaming, sharing video or audio files, or any other network based services.

The processors 124 can be any type of processor, including one or more central processing units (CPUs), graphic processing units (GPUs), field programmable gate arrays (FPGAs), and/or application specific integrated circuits (ASICs).

Although FIG. 1 functionally illustrates the memory 118 and processors 124 as being within a single block of the host machines 112, it should be understood that the memory 118 and/or processors 124 can include multiple memories or processors that may or may not be located or stored within the same physical housing.

The storage 114 can include a disk or other storage device that is partitionable to provide physical or virtual storage to virtual machines running on processing devices within the platform 110. Storage 114 can include local or remote storage, e.g., on a storage area network (SAN), that stores data accumulated for one or more applications on the platform 110.

The infrastructure 116 can include switches, physical links, e.g., fiber, and other equipment used to interconnect host machines 112 with storage 114 within the platform 110. The infrastructure 116 can include data buses or other connections between components internal to a computing device as well as connections between computing devices, such as a local area network, virtual private network, wide area network, or other types of networks.

One or more host machines 112 or other computer systems within the first platform 110 can be configured to act as a supervisory agent or hypervisor in creating and managing virtual machines associated with one or more host machines 112. In general, a host or computer system configured to function as a hypervisor will contain the instructions necessary to, for example, manage the operations that result from provisioning or maintaining compute resources and/or run applications on the first platform 110.

The second platform 130 can be configured similarly to the first platform 110, with one or more host machines 132 and storage 134 connected via infrastructure 136. Each host machine 132 can include memory 138 for storing instructions 140 and data 142, and one or more processors 144 for executing the instructions 140 using the data 142. As noted earlier, the environment 100 can include any number of platforms for migrating multi-asset applications therebetween using the approach described further below.

The network 150 can include various configurations and protocols including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi, HTTP, etc., and various combinations of the foregoing. Such communication may be facilitated by any device capable of transmitting data to and/or from other computing devices, such as modems and wireless interfaces. The platforms 110, 130 can interface with the network 150 through communication interfaces, which can include hardware, drivers, and software necessary to support a given communications protocol.

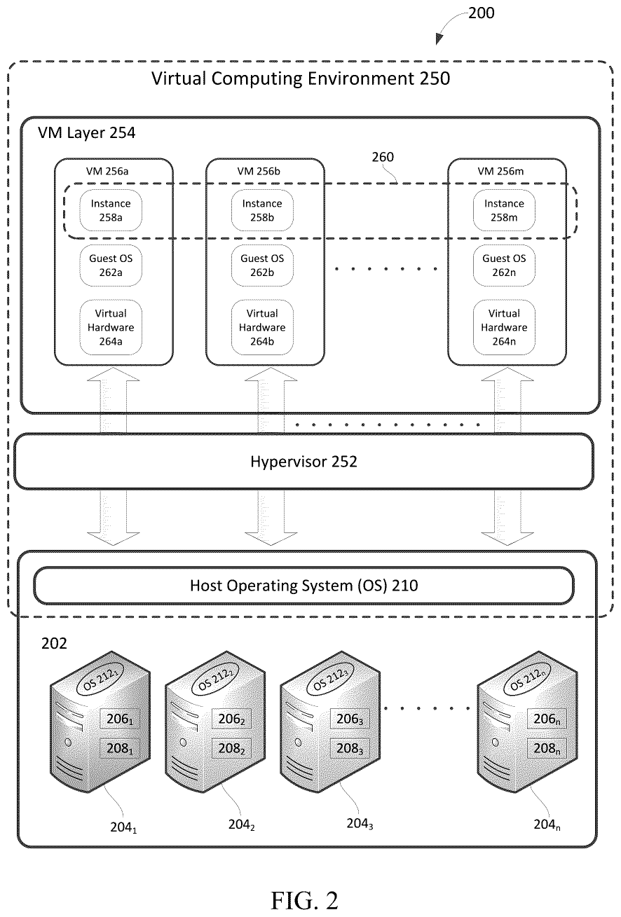

FIG. 2 depicts a block diagram of an example platform 200, which can be the first platform 110 or second platform 130 of the environment 100. The platform 200 can include a collection 202 of host machines 204, e.g., hardware resources, supporting or executing a virtual computing environment 250. The host machines 204 can correspond to the host machines 112 or 132 of FIG. 1. The virtual computing environment 250 can include a virtual machine manager or hypervisor 252 and a virtual machine layer 254 running one or more virtual machines 256 configured to execute instances 258 of one or more multi-asset applications 260.

Each host machine 204 can include one or more physical processors 206, e.g., data processing hardware, and associated physical memory 208, e.g., memory hardware. While each host machine 204 is shown having a single physical processor 206, the host machines 204 can include multiple physical processors 206. The host machines 204 can also include physical memory 208, which may be partitioned by a host operating system (OS) 210 into virtual memory and assigned for use by the virtual machines 256, the hypervisor 252, or the host OS 210. Physical memory 208 can include random access memory (RAM) and/or disk storage, including storage 114 accessible via infrastructure 116, as shown in FIG. 1.

The host OS 210 can execute on a given one of the host machines 204 or can be configured to operate across a plurality of the host machines 204. For convenience, FIG. 2 shows the host OS 210 as operating across the plurality of machines 204. Further, while the host OS 210 is illustrated as being part of the virtual computing environment 250, each host machine 204 is equipped with its own OS 212. However, from the perspective of a virtual environment, the OS 212 on each machine 204 appears as and is managed as a collective OS 210 to the hypervisor 252 and the virtual machine layer 254.

The hypervisor 252 can correspond to a compute engine that includes at least one of software, firmware, or hardware configured to create, instantiate/deploy, and execute the virtual machines 256. Each virtual machine 256 can be referred to as a guest machine. The hypervisor 252 can be configured to provide each virtual machine 256 with a corresponding guest OS 262 having a virtual operating platform and to manage execution of the corresponding guest OS 262 on the virtual machine 256. In some examples, multiple virtual machines 256 with a variety of guest OSs 262 can share virtualized resources. For example, virtual machines of different operating systems can all run on a single physical host machine.

The host OS 210 can virtualize underlying host machine hardware and manage concurrent execution of a guest OS 262 on the one or more virtual machines 256. For example, the host OS 210 can manage the virtual machines 256 to include a simulated version of the underlying host machine hardware or a different computer architecture. The simulated version of the hardware associated with each virtual machine 256 can be referred to as virtual hardware 264.

The virtual hardware 264 can include one or more virtual processors, such as virtual central processing units (vCPUs), emulating one or more physical processors 206 of a host machine 204. The virtual processors can be interchangeably referred to as a computing resource associated with the virtual machine 256. The computing resource can include a target computing resource level required for executing the corresponding individual service instance 258 of the multi-asset application 260.

The virtual hardware 264 can further include virtual memory in communication with the virtual processor and storing guest instructions executable by the virtual processor for performing operations. The virtual memory can be interchangeably referred to as a memory resource associated with the virtual machine 256. The memory resource can include a target memory resource level required for executing the corresponding individual service instance 258.

The virtual hardware 264 can also include at least one virtual storage device that provides run time capacity for the service on the host machine 204. The at least one virtual storage device may be referred to as a storage resource associated with the virtual machine 256. The storage resource may include a target storage resource level required for executing the corresponding individual service instance 258.

The virtual processor can execute instructions from the virtual memory that cause the virtual processor to execute a corresponding individual service instance 258 of the software application 260. The individual service instance 258 can be referred to as a guest instance that cannot determine if it is being executed by the virtual hardware 264 or the physical host machine 204. The processors 206 of the host machine 204 can enable the virtual hardware 264 to execute software instances 258 of the multi-asset application 260 efficiently by allowing guest software instructions to be executed directly on the processor 206 of the host machine 204 without requiring code-rewriting, recompilation, or instruction emulation.

The guest OS 262 executing on each virtual machine 256 can include software that controls the execution of the corresponding individual service instance 258 of the multi-asset application 260 by the virtual machines 256. The guest OS executing on a virtual machine can be the same or different as other guest OSs executing on other virtual machines. The guest OS 262 executing on each virtual machine 256 can further assign network boundaries, e.g., allocate network addresses, through which respective guest software can communicate with other processes reachable through infrastructure, such as an internal network. The network boundaries may be referred to as a network resource associated with the virtual machine 256.

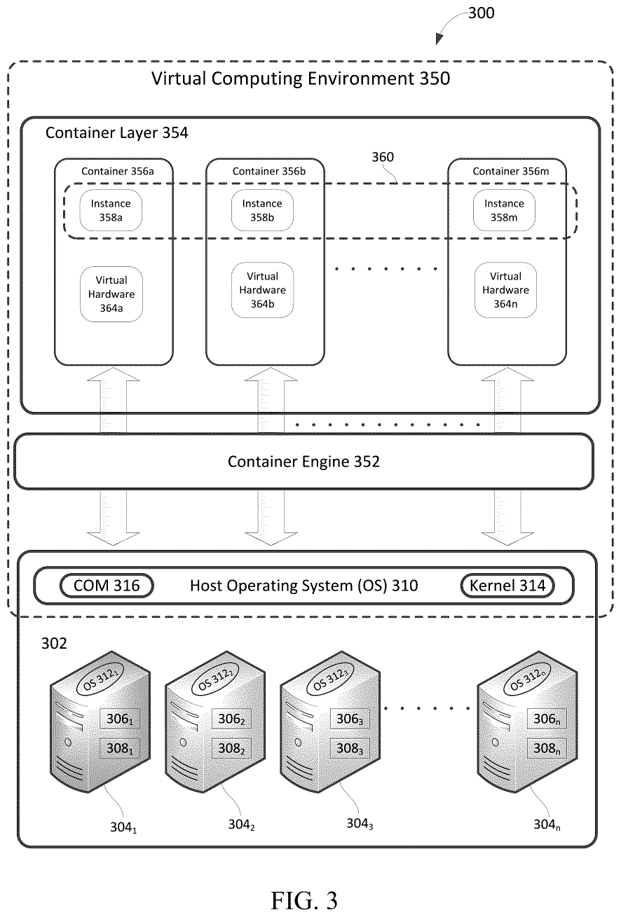

FIG. 3 depicts a block diagram of another example platform 300, which can be the first platform 110 or second platform 130 of the environment 100. The platform 300 can include a collection 302 of host machines 304 supporting or executing a virtual computing environment 350. The host machines 304 can correspond to the host machines 112 or 132 of FIG. 1. The virtual computing environment 350 can include a container engine 352 and a container layer 354 running one or more containers 356 configured to execute instances 358 of a multi-asset software application 360.

As described with respect to FIG. 2, each host machine 304 can include one or more physical processors 306 and associated physical memory 308. While each host machine 304 is shown having a single physical processor 306, the host machines 304 can include multiple physical processors 306. Further, each host machine 304 is equipped with its own OS 312. However, from the perspective of a virtual environment, the OS 312 on each machine 304 appears as and is managed as a collective OS 310 to the container engine 352 and the container layer 354.

The container engine 352 can correspond to a compute engine that includes at least one of software, firmware, or hardware configured to create, instantiate/deploy, and execute the containers 356.

The host OS 210 can virtualize underlying host machine hardware for each container, which can be referred to as virtual hardware 364. The virtual hardware 364 can include one or more virtual processors emulating one or more physical processors 306 of a host machine 304. The virtual hardware 364 can further include virtual memory in communication with the virtual processor and storing guest instructions executable by the virtual processor for performing operations. The virtual hardware 364 can also include at least one virtual storage device that provides run time capacity for the service on the host machine 304. The virtual processor can execute instructions from the virtual memory that cause the virtual processor to execute a corresponding individual service instance 358 of the multi-asset application 360.

The containers 356 do not include a guest OS to execute an individual service instance of the multi-asset application 360. Instead, the host OS 310 can include virtual memory reserved for a kernel 314 of the host OS 310. The kernel 226 can include kernel extensions and device drivers to perform operations to manage the containers 356, such as ensuring each container has its own mount point, networks interfaces, user identifiers, process identifiers, etc. A communication process 316 running on the host OS 310 can provide a portion of virtual machine network communication functionality to communicate with the container engine 352 and kernel 314 of the host OS 310.

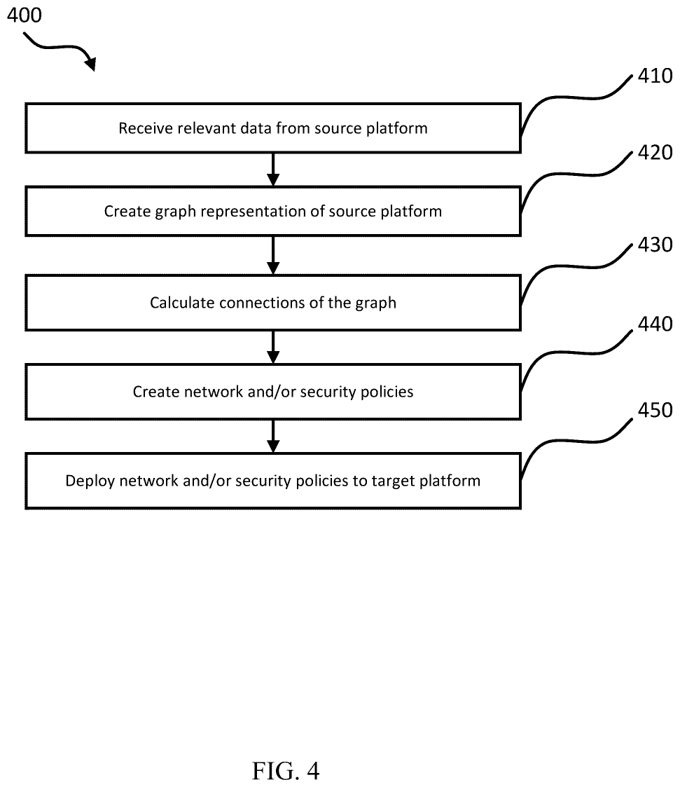

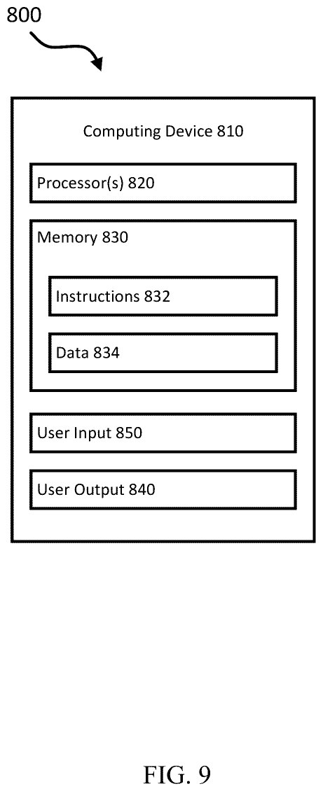

FIG. 4 depicts a flow diagram of an example process 400 for migrating multi-asset applications from a source platform to a target platform, such as from first platform 110 to second platform 130 of FIG. 1. The example process 400 can be performed on a system of one or more processors in one or more locations, such as the example computing system 800 of FIG. 9, to be described further below. An asset can be an atomic migratable unit that includes any processing, storage, and/or network infrastructure on which the application relies to function. Example assets include virtual machines, virtualized components inside a virtual machine, databases, storage sharing components, and containers.

As shown in block 410, relevant data for identifying the multi-asset applications is received from the source platform. Relevant data can include asset information, network connection information, and/or process information. Asset information can include data to uniquely identify an asset, such as Internet protocol (IP) addresses, transmission control protocol (TCP) addresses, and user datagram protocol (UDP) addresses, as well as storage information and file systems. Network connection information can include data to identify connections between assets, such as TCP streams between a database and an application, connections to remote storage, and proprietary protocols implemented over a UDP, as well as network interfaces, network routes, network tunnels, pipes, and endpoints. Process information can include data to identify functions of one or more assets, such as application servers, application databases, operating systems, scheduled jobs, access controls, and firewall rules.

The relevant data can be gathered from existing data using detection logic and/or refined using an enriching or assessment tool. Data refinement can include enhancing the existing data with missing or incomplete data, typically from a data source other than the source platform. The relevant data can be received once in anticipation of a migration or can be polled periodically such that the data is up to date for a migration.

As shown in block 420, based on the received relevant data, a graph is created to represent the components of the source platform. The graph can include nodes and edges. Nodes can represent assets, such as virtual machines, containers, processes, storage systems, and databases. Edges can represent relations between the assets, such as network connections, storage connections, and interprocess connections.

The nodes of the graph can be determined from the asset information and/or process information of the relevant data. For example, data from a hypervisor, a container engine, an OS, or one or more applications can determine nodes of the graph. Data from a hypervisor can include virtual machines or network interfaces from a hypervisor listing. Data from a container engine can include containers for applications. Data from an OS can include processes such as a process list, network listing interfaces, Internet protocol commands and configurations, and storage processes. Data from the applications can include database instances, proxy configurations, and runtime environments.

As shown in block 430, connections of the graph are calculated to identify multi-asset applications of the source platform, for example, by using a graph traversal algorithm. The edges of the graph can be determined from the network connection information of the relevant data, such as TCP connections, network tunnels, pipes, and endpoints. For example, a storage device and its connections can be determined from a protocol, an endpoint and/or port, and a network file system (NFS) export of a server message block (SMB) share. As another example, a database and its connections can be determined from a protocol, an endpoint and/or port, a database type, and a database name.

Two assets having a logical relationship are represented in the graph by two nodes connected with an edge. The edge can include a direction from one node to the other node to represent a dependency between the two assets. Example dependencies can include a load balancer being dependent on an application server and a process being dependent on a database and storage.

Additional edges can be created to represent additional logical relationships determined from the calculations, as additional relevant data for identifying the multi-asset applications is received from the source platform. For example, relevant data to load balancers can lead to connecting multiple identified micro services over already existing calculated components.

A grouping of at least two nodes connected by an edge can represent a multi-asset application.

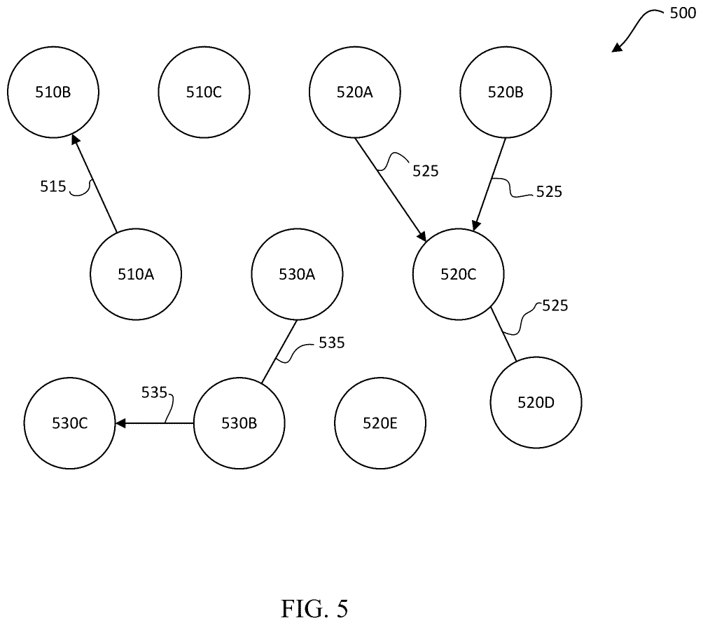

FIG. 5 depicts an example graph representation 500 of a platform. The graph includes a plurality of nodes 510A-C, 520A-E, and 530A-C representing assets and a plurality of edges 515, 525, and 535 representing relations between the assets. Some of the edges can be directed to represent dependencies between the assets. For example, node 510A can represent a process, such as a web server, and node 510B can represent a database. The directed edge 515 between nodes 510A and 510B can represent a network connection where the process, such as the web server, is dependent on the database. The other nodes and edges can represent other assets and relationships, respectively.

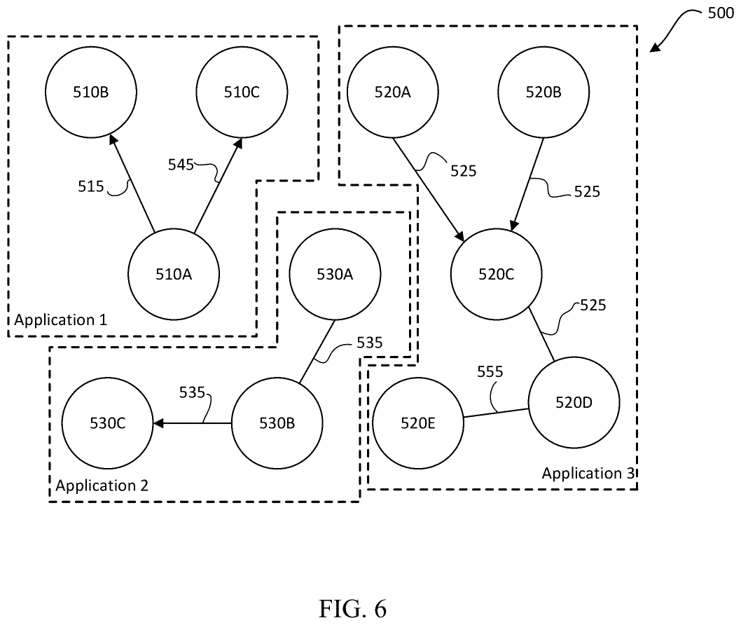

FIG. 6 depicts the example graph representation 500 of a platform where additional connections are calculated, and the multi-asset applications are identified. From the calculations, additional logical relationships can be determined between nodes 510A and 510C and between nodes 520D and 520E. Therefore, directed edge 545 and edge 555 can be added to connect nodes 510A and 510C and connect nodes 520D and 520E, respectively. For example, node 510C can represent a storage device, such as a network file system (NFS). Since the process, represented by node 510A, can be dependent on a storage device, such as the NFS, an additional network connection is created, represented by directed edge 545, to connect node 510A with node 510C. NFS can be used for applications that require dedicated storage such as disaster recovery and backup applications, as well as for sharing data between applications. Edge 555 can represent another determined connection between nodes 520D and 520E.

Nodes 510A, 510B, and 510C connected by edges 515 and 545 can represent a first multi-asset application. Similarly, nodes 520A-E connected by edges 525 and 555 can represent a second multi-asset application and nodes 530A-C connected by edges 535 can represent a third multi-asset application. While three applications are shown, it should be noted that any number of applications can be represented by the graph. Further, the applications can include any number of nodes connected by any number of edges. While not shown, the applications can have assets that overlap, such as an asset for a first application also being included as an asset for a second application. For example, a database asset can serve multiple applications, where the separation between applications of the database asset can be determined by scanning the database configuration.

Referring back to FIG. 4, as shown in block 440, network and/or security policies are created for the identified multi-asset applications based on the graph. The connections of the graph are analyzed to aid in migrating the multi-asset applications to the target platform. For example, assets of the multi-asset applications can be identified to be stateless or stateful. Relevant migrations plans can be determined based on whether the multi-asset applications include stateless or stateful assets. Gradual traffic redirection can be preferable for stateless assets while a replication and transfer plan can be preferable for stateful assets. As another example, asset information or network connection information that should be updated during migration are identified, such as endpoints, addresses, and DNS entries. As yet another example, dependencies are identified to determine a migration order for the assets of the multi-asset applications as well as the multi-asset applications themselves. Additional network and/or security policies can include using virtual machine addresses to define a network subnet classless inter-domain routing (CIDR) block, determining which ports to expose from aggregated connections or storage connections, determining which assets can be accessible to other assets from edges of the graph, configuring user access to migrated resources, and configuring load balancer routes based on the connections of the graph.

As shown in block 450, the created network and/or security policies can be deployed to the target platform. The connections of the graph are mapped to resources of the target platform such that functionality of the multi-asset applications can be maintained during migration. For example, the infrastructure in the target platform can be configured to reflect the infrastructure in the source platform, such as by allocating the same IP and/or MAC addresses for migrated virtual machines or configuring DNS entries. As another example, the multi-asset applications can be configured to reflect the target platform, such as by changing a backend application configured to use a database in the target platform.

The assets can be migrated to the target platform and configured to run on the target platform during migration or as soon as the migration is complete based on the network and security policies. IPs can be preserved in the target platform or alias IPs can be created in the target platform for the assets of the identified multi-asset applications. DNS entries can be identified and rewritten with data from the target platform during the migration process. Further, OS-level or application-level configurations, such as IPs and endpoints, can be identified and rewritten with data from the target platform during the migration process. Traffic is gradually redirected from backends of the source platform to backends of the target platform until the migration process is complete.

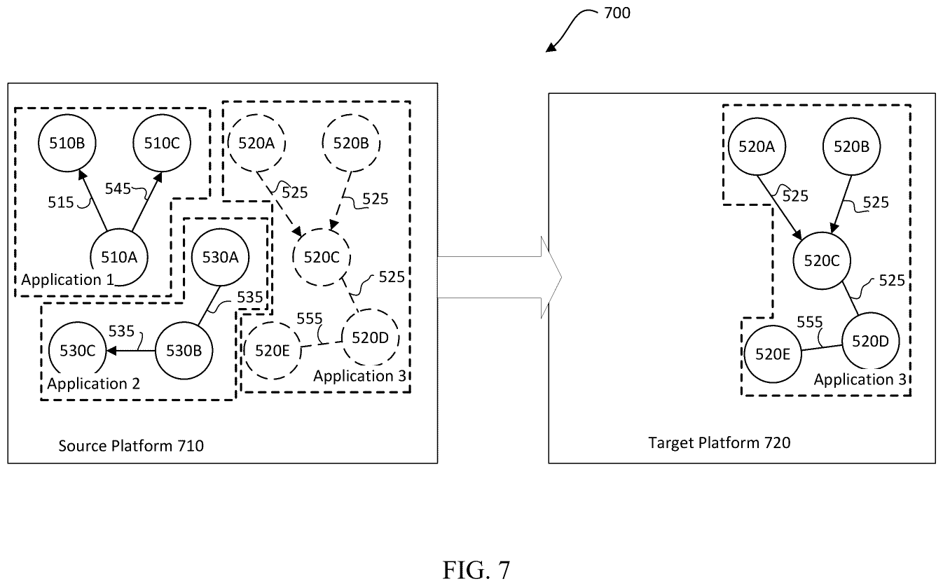

FIG. 7 depicts an example migration 700 from a source platform 710 to a target platform 720 based on the example graph representation 500. Based on the created network and/or security policies deployed on the target platform, the third multi-asset application is migrated from the source platform 710 to the target platform 720. The assets in the third application can run on the target platform 720 while the assets in the first and second applications run on the source platform 710.

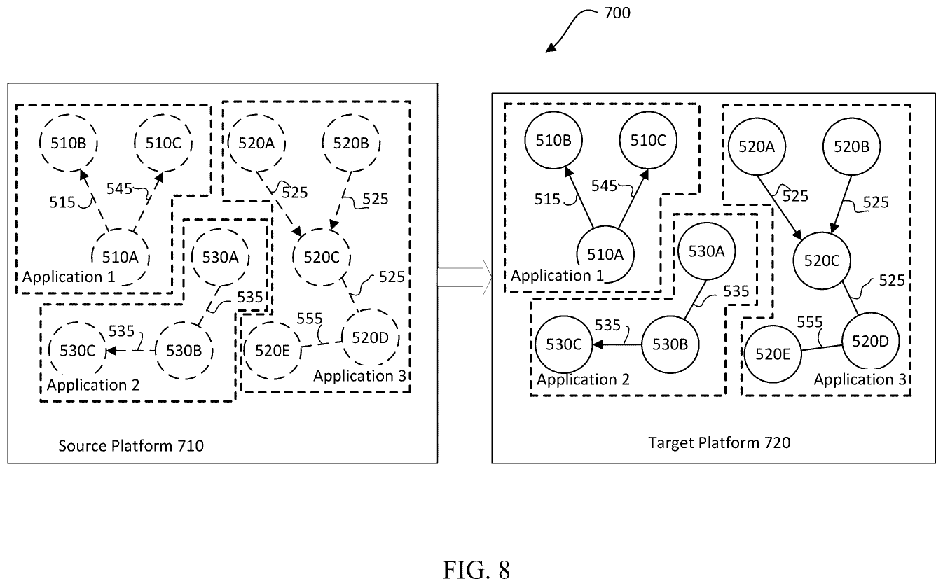

FIG. 8 depicts the example migration 700 at completion. Here, the assets in the first and second applications can run on the target platform 720 as well. Traffic can be fully directed to backends of the target platform. Maintenance of the source platform can be discontinued, and the target platform can be solely relied upon for utilizing the multi-asset applications.

FIG. 9 depicts a block diagram of an example computing system 800 for performing a multi-asset application migration, such as the process 400 depicted in FIG. 4. The system 800 can be implemented on one or more computing devices 810 in one or more locations, such as in a server or client computing device. The computing device 810 can be communicatively coupled to platforms for migration, such as platforms 110 and 130 of FIG. 1, over a network, such as the network 150 of FIG. 1.

The computing device 810 can include one or more processors 820 and memory 830. The memory 830 can store information accessible by the processors 820, including instructions 832 that can be executed by the processors 820. The memory 830 can also include data 834 that can be retrieved, manipulated, or stored by the processors 820. The memory 830 can be a type of non-transitory computer readable medium capable of storing information accessible by the processors 820, such as volatile and non-volatile memory. The processors 820 can be any type of processor, including one or more central processing units (CPUs), graphic processing units (GPUs), field-programmable gate arrays (FPGAs), and/or application-specific integrated circuits (ASICs), such as tensor processing units (TPUs).

The instructions 832 can include one or more instructions that, when executed by the processors 820, causes the one or more processors 820 to perform actions defined by the instructions 832. The instructions 832 can be stored in object code format for direct processing by the processors 820, or in other formats including interpretable scripts or collections of independent source code modules that are interpreted on demand or compiled in advance.

The data 834 can be retrieved, stored, or modified by the processors 820 in accordance with the instructions 832. The data 834 can be stored in computer registers, in a relational or non-relational database as a table having a plurality of different fields and records, or as JSON, YAML, proto, or XML documents. The data 834 can also be formatted in a computer-readable format such as, but not limited to, binary values, ASCII or Unicode. Moreover, the data 834 can include information sufficient to identify relevant information, such as numbers, descriptive text, proprietary codes, pointers, references to data stored in other memories, including other network locations, or information that is used by a function to calculate relevant data.

If the computing device 810 is a client computing device, the computing device 810 can also include a user output 840 and a user input 850. The user output 840 can be configured for displaying an interface and/or include one or more speakers, transducers or other audio outputs, a haptic interface or other tactile feedback that provides non-visual and non-audible information to a user of the computing device 810. The user input 850 can include any appropriate mechanism or technique for receiving input from a user, such as keyboard, mouse, mechanical actuators, soft actuators, touchscreens, microphones, and sensors.

Although FIG. 9 illustrates the processors 820 and the memory 830 as being within the computing device 810, components described in this specification can include multiple processors and memories that can operate in different physical locations and not within the same computing device. For example, some of the instructions 832 and the data 834 can be stored on a removable SD card and others within a read-only computer chip. Some or all of the instructions 832 and data 834 can be stored in a location physically remote from, yet still accessible by, the processors 820. Similarly, the processors 820 can include a collection of processors that can perform concurrent and/or sequential operations. The computing device 810 can include one or more internal clocks providing timing information, which can be used for time measurement for operations and programs run by the computing device 810.

As such, generally disclosed herein is an approach for migrating multi-asset applications from a first platform to a second platform. The approach can include identifying multi-asset applications from creating a graph to represent the first platform. Nodes can be assets, such as virtual machines, processes, storage systems, and databases. Edges can be relations between the assets, such as network connections, storage connections, and interprocess connections. The edges can connect two nodes to illustrate a logical relationship between two assets. A grouping of at least two nodes connected by an edge can represent a multi-asset application. The approach allows for maintaining functionality of multi-asset applications during migration to a target platform. For example, connectivity between dependent assets can be maintained during the migration process, since the dependencies have been identified. The system can remain operational during migration, even if migration occurs in parts.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for migrating multi-asset applications from a first platform to a second platform, the method comprising:
receiving, with one or more processors, data for identifying one or more multi-asset applications of the first platform;
creating, with the one or more processors, a graph representation of the first platform based on the received data, the graph representation comprising a plurality of nodes representing assets of the first platform;
calculating, with the one or more processors, connections between the nodes based on logical relationships between the assets, the graph representation further comprising a plurality of edges between nodes representing the connections;
identifying, with the one or more processors, the multi-asset applications based on the connections between the nodes; and
migrating, with the one or more processors, the identified multi-asset applications from the first platform to the second platform.

2. The method of claim 1, further comprising:
creating, with the one or more processors, policies for the identified multi-asset applications; and
deploying, with the one or more processors, the policies on the second platform;
wherein migrating, with the one or more processors, the identified multi-asset applications from the first platform to the second platform is based on the policies.

3. The method of claim 2, wherein the identified multi-asset applications run on the second platform during migration.

4. The method of claim 2, wherein the policies comprise network and security policies.

5. The method of claim 1, further comprising mapping, with the one or more processors, the calculated connections to resources of the second platform.

6. The method of claim 5, wherein mapping the calculated connections comprises one of configuring the second platform to reflect infrastructure in the first platform or configuring the multi-asset applications to reflect the target platform.

7. The method of claim 1, wherein the received data comprises one or more of asset information uniquely identifying one or more assets, network connection information identifying one or more connections between assets, or process information identifying functions of one or more assets.

8. The method of claim 1, wherein two nodes connected by an edge represent a multi-asset application.

9. A system comprising:
one or more processors; and
one or more storage devices coupled to the one or more processors and storing instructions that, when performed by the one or more processors, causes the one or more processors to perform operations for migrating multi-asset applications from a first platform to a second platform, the operations comprising:
receiving data for identifying one or more multi-asset applications of the first platform;
creating a graph representation of the first platform based on the received data, the graph representation comprising a plurality of nodes representing assets of the first platform;
calculating connections between the nodes based on logical relationships between the assets, the graph representation further comprising a plurality of edges between nodes representing the connections;
identifying the multi-asset applications based on the connections between the nodes; and
migrating the identified multi-asset applications from the first platform to the second platform based on the calculated connections.

10. The system of claim 9, wherein the operations further comprise:
creating policies for the identified multi-asset applications; and
deploying the policies on the second platform;
wherein migrating the identified multi-asset applications from the first platform to the second platform is based on the policies.

11. The system of claim 10, wherein the identified multi-asset applications run on the second platform during migration.

12. The system of claim 10, wherein the policies comprise network and security policies.

13. The system of claim 9, wherein the operations further comprise mapping the calculated connections to resources of the second platform.

14. The system of claim 13, wherein mapping the calculated connections comprises one of configuring the second platform to reflect infrastructure in the first platform or configuring the multi-asset applications to reflect the target platform.

15. The system of claim 9, wherein the received data comprises one or more of asset information uniquely identifying one or more assets, network connection information identifying one or more connections between assets, or process information identifying functions of one or more assets.

16. The system of claim 9, wherein two nodes connected by an edge represent a multi-asset application.

17. A non-transitory computer readable medium for storing instructions that, when executed by one or more processors, causes the one or more processors to perform operations for migrating multi-asset applications from a first platform to a second platform, the operations comprising:
receiving data for identifying one or more multi-asset applications of the first platform;
creating a graph representation of the first platform based on the received data, the graph representation comprising a plurality of nodes representing assets of the first platform;
calculating connections between the nodes based on logical relationships between the assets, the graph representation further comprising a plurality of edges between nodes representing the connections;
identifying the multi-asset applications based on the connections between the nodes; and
migrating the identified multi-asset applications from the first platform to the second platform based on the calculated connections.

18. The non-transitory computer readable medium of claim 17, wherein the operations further comprise:
creating policies for the identified multi-asset applications; and
deploying the policies on the second platform;
wherein migrating the identified multi-asset applications from the first platform to the second platform is based on the policies.

19. The non-transitory computer readable medium of claim 17, wherein the operations further comprise mapping the calculated connections to resources of the second platform.

20. The non-transitory computer readable medium of claim 19, wherein mapping the calculated connections comprises one of configuring the second platform to reflect infrastructure in the first platform or configuring the multi-asset applications to reflect the target platform.
